(19) United States
(12) Patent Application Publication
(10) Pub. No.: US 2004/0034820 A1
(43) Pub. Date: Feb. 19, 2004

(54) Apparatus and method for pseudorandom rare event injection to improve verification quality

(76) Inventors: Donald C. Soltis, JR., Ft. Collins, CO (US); Don Douglas Josephson, Ft. Collins, CO (US); Paul K. French, Ft. Collins, CO (US); Russell C. Brockmann, Ft. Collins, CO (US); Kevin David Safford, Ft. Collins, CO (US); Jeremy Petsinger, Ft. Collins, CO (US); Karl P. Brummel, Chicago, IL (US)

Correspondence Address: HEWLETT-PACKARD COMPANY, Intellectual Property Administration, P.O. Box 272400, Fort Collins, CO, 80527-2400, US

(21) Appl. No.: 10/219,203

(22) Filed: Aug. 15, 2002

(51) Int. Cl. H04B 1/74

(52) U.S. Cl. 714/47

(57) ABSTRACT

A rare-event injector for generating events in an integrated circuit has circuitry for generating a pseudorandom sequence of events. This pseudorandom sequence of events is injected into circuitry of the integrated circuit to stimulate error handling and recovery circuitry of the integrated circuit.

### FIELD OF THE INVENTION

The invention relates to diagnostic apparatus and methods for complex integrated circuits, and for systems embodying complex integrated circuits.

### BACKGROUND OF THE INVENTION

The Integrated Circuit (IC) industry is evolving rapidly. Many processor integrated circuits marketed in 2002 have ten or more times the performance of the processors of 1992. Memory has become far faster, denser, and much less expensive than it was only a few years ago. Other types of integrated circuits have also evolved rapidly. It is therefore necessary for each manufacturer to continually design new products if they are to continue producing competitive devices.

Newer IC processes allow smaller devices than older processes. Small devices require less charge injection than large devices to cause a ‘soft error’. Ionizing radiation, including cosmic rays and alpha particles from packaging materials, can inject charge thereby causing soft errors. Soft errors are typically random, nonrepeatable, errors. With these processes, error detection and/or correction is important, yet soft errors are still rare and post-silicon verification of the detection and correction hardware is difficult.

Error Windows

Complex Integrated Circuits (ICs) often have multiple functional units that have interactions with external circuitry and other functional units. These interactions are often sensitive to timing relationships between events.

Consider a processor integrated circuit. Processors generally provide an interrupt mechanism. An interrupt mechanism allows events in peripheral units, which may but need not be on the same IC, to stop execution of a process running on the processor, saving critical processor state information, and start execution of another process. Design errors could cause the processor state information to be properly saved if the interrupt happens in most states of a machine, but if the interrupt happens in a particular state, or error window, the information may be saved incorrectly.

There are many other opportunities for design errors or fabrication problems to result in sensitivity of a complex integrated circuit to the exact relationship between events both internal and external. For example, it is possible that an error window could exist in data delivery to an execution pipeline in a processor from an internal cache. Similarly, an error window could exist wherein an error in cache memory is not corrected properly if certain other events happen at just the right time.

An error window is a period of time in which a particular stimulus event is processed incorrectly. The time period of an error window is relative to other events within the circuit.

When a design for a new integrated circuit is prepared, it is necessary to verify that the design is correct through a process called design verification. It is known that design verification can be an expensive and time-consuming process. It is also known that design errors found during pre-silicon simulation are generally inexpensive to fix, those found during post-silicon design verification are more expensive to fix, and those discovered after customer shipments begin can provoke enormously expensive product recalls.

It is highly desirable to test for as many error windows in IC prototypes as possible, so that workarounds may be found, or the IC design fixed, before large numbers of ICs are built.

In addition to identifying design errors in the IC, it is also necessary to identify design flaws in other system components, including other ICs and operating system software. It is known that “bugs” in rare-event processing routines of such software are sometimes difficult to find. In particular, it is desirable to exercise error-handling routines in operating system error-handling, logging, and recovery software before systems reach customers, such that these routines may be debugged.

Test Circuitry

Complex ICs generally offer limited visibility to interactions of their internal functional units. Limited visibility means that signals relating to these interactions are often not available at chip pins or other readily accessible locations including register bits.

It is known that test circuitry may be added to an IC design to increase visibility during debug and design verification. Test circuitry may record internal events for analysis, or may select one or more of many signals to be brought out on chip pins for analysis.

While it is known that rare events can be injected by overriding simulation values during simulation, rare-event injection in actual integrated circuits requires on-chip hardware support.

Cache Memory

Many modem high-performance processors implement a memory hierarchy having several levels of memory. Each level typically has different characteristics, with lower levels typically smaller and faster than higher levels.

A Cache Memory is typically a lower level of a memory hierarchy. There are often several levels of cache memory, one or more of which are typically located on the processor integrated circuit. Cache memory is typically equipped with mapping hardware for establishing a correspondence between cache memory locations and locations in higher levels of the memory hierarchy. The mapping hardware typically provides for automatic replacement (or eviction) of old cache contents with newly referenced locations fetched from higher-level members of the memory hierarchy. This mapping hardware often makes use of a cache tag memory. For purposes of this application cache mapping hardware will be referred to as a tag subsystem.

Many programs access memory locations that have either been recently accessed, or are located near recently accessed locations. These locations are likely to be found in fast cache memory, and therefore more quickly accessed than other locations. For these reasons, it is known that cache memory often provides significant performance advantages.

Error Detection and Correction

Modern processor ICs may have large cache memory units, sometimes consuming as much as half the total IC area.

Large, fast, memory units, including cache memory units, are known to occasionally develop errors. Many of these errors are “soft errors”, errors caused by random events such as impact of cosmic radiation or alpha particles from radioactive elements in packaging materials. Some modem memory units, including some cache memory units, provide error detection and correction logic, wherein single-bit errors are detected as data is read. Detected errors are then repaired such that correct data is provided to other units on the IC. Some devices also provide for detection and/or correction of multiple-bit errors.

It is known that, while cache memory soft errors are rare events, on-chip error detection and correction logic can provide significant improvements in overall system reliability.

Error detection and correction logic often causes a delay to allow for correction when errors are detected. While this delay is often brief if correction can be performed using information stored in the memory, correction of some errors in low levels of a memory hierarchy may involve accessing higher-level memory. In IC designs having such a correction delay, it is necessary to verify, during design verification, that the delay does not cause faulty operation of other circuitry in the IC.

Disabling Test Modes In Customer Systems

When test modes that can disrupt normal operation, including test modes that inject errors into cache memories, are present in an IC design; it is often desirable to prevent undesired activation of the test modes in a customer's system.

### SUMMARY

An integrated circuit is built with internal test circuitry capable of detecting certain events within the integrated circuit.

An output of the test circuitry provides a trigger to an on-chip injector. The on-chip injector causes an event to happen at a deterministic, yet pseudorandom, time relative to the trigger. The on-chip injector is additionally capable of generating repeated events at a pseudorandom interval thereafter.

In a particular embodiment, the on-chip injector incorporates a Linear-Feedback Shift Register (LFSR) to cause a pseudorandom sequence of events at particular times.

In a particular embodiment, the injector is capable of injecting a variety of events, including inserting single-bit cache read errors ahead of error-detection and correction logic. In this embodiment, the injector is also capable of injecting double-bit read errors into cache, parity errors in TLB (translation lookaside buffer) locations, and parity errors in other on-chip parity-protected structures such as branch-prediction circuitry.

In another embodiment, the injector is capable of causing delays in response by a cache to a read operation.

In another embodiment, the injector is capable of forcing processor pipeline stalls or processor pipeline flush operations. In this embodiment, the injector is also capable of causing branch mispredictions.

The particular embodiment of the on-chip injector is used during design verification to ensure that events similar to those injected do not cause uncorrected faulty operation of the IC. The injector is also used to verify error handling, error logging and error recovery software.

### BRIEF DESCRIPTION OF THE DRAWINGS

FIG. 1 is a block diagram of test circuitry for injecting rare events, with logic for injecting errors into a cache read path;

FIG. 2, a block diagram of a complex processor integrated circuit having multiple event injectors;

FIG. 3, a block diagram of an event synchronizer for the present invention;

FIG. 4, a block diagram of an event generator for the present invention; and

FIG. 5, a flowchart of a portion of design verification of a complex integrated circuit, wherein a pseudorandom event injector is used to verify correct operation of the integrated circuit and of an operating system having error recovery features.

### DETAILED DESCRIPTION OF THE EMBODIMENTS

Within a complex integrated circuit, a pseudorandom rare-event injector 100 is provided. The pseudorandom rare event injector includes a Linear Feedback Shift Register (LFSR) 102. In a particular embodiment the LFSR is a 15-bit LFSR, however other embodiments are of other lengths.

The LFSR 102 is coupled to a trigger event 104 such that it loads with contents of a programmable initial value register 106 upon the trigger event. In a particular embodiment, trigger event 104 is generated by a processor of the integrated circuit referencing a particular location, however it is anticipated that other trigger events, including events brought in on a pin, may be used.

The LFSR 102 produces a pseudorandom pattern that is bitwise AND-ed 108 with contents of a programmable compare value register 110. This bitwise AND 108 effectively selects a particular subset of bits of the LFSR as bits that matter for event generation; remaining bits are effectively ignored.

Next, results of the bitwise AND 108 are provided to a reduction-OR gate 112. Reduction OR 112 effectively verifies that all relevant bits of the LFSR 102 are in a particular state. Bitwise AND 108 and reduction OR 112 logic as shown will require that all bits of the LFSR that matter are in a particular state to generate an event. It is anticipated that the bitwise AND 108 and reduction OR 112 may be replaced with a bitwise OR and reduction AND to generate events when relevant bits of the LFSR are all in a particular state.

A pseudorandom pulse train output 113 of the reduction OR is brought to an event synchronizer 114, detailed in FIG. 3. The event synchronizer 114 is configurable, through multiplexor 302 to allow unsynchronized injection of events, or to synchronize events to synchronization events in a synch mode. In synch mode, each pulse of the pseudorandom pulse train 113 sets an SR flipflop 304 Synchronization events in a particular embodiment are selected from events that may occur internal to the integrated circuit including:

a. CPU-originated cache read references that “hit” in cache;

b. TLB-read operations; and

c. Branch operation instruction decode.

These synchronization events are selected by a multiplexor 306, AND-ed 308 with SR flipflop 304, and latched by a D-flipflop 310. D-flipflop 310 resets the SR flipflop 304.

Pulses from the event synchronizer 114 feed event generator 115, detailed in FIG. 4. The event generator 115 uses a delay register 400, delay downcounter 402, and zero-detector 404 to delay event pulses by a configurable time. The event generator 115 also uses a width register 410, width downcounter 412, and zero-detector 414 to stretch event pulses to a configurable length.

Synchronized, stretched, and delayed, events feed enablement logic and decoder 420.

The pseudorandom rare-event injector 100 operates under control of control logic 116 and is configured over a test bus 118. In an embodiment, the test bus 118 is accessible through I/O operations performed by a processor of the IC, in another embodiment, test bus 118 is accessible from outside the integrated circuit through a serial interface.

In a particular embodiment where the complex integrated circuit is a processor integrated circuit, an event generator output 130 of the pseudorandom rare-event injector is brought to a rare-event stimulus input of an exclusive-OR gate 132. In this embodiment, data is read from cache memory 134 through column multiplexors 136. Most bits of the data pass to error detect and control circuitry 138, a selected bit, or in a multiple bit mode two bits, of the data passes through exclusive-OR gate 132 to the error detect and correction circuitry 138. The event generator output 130 of the rare-event injector 100 thereby causes single-bit corruption of the data as read into the error detect and correction circuitry 138, allowing exercising of the error detect and correction circuitry and other associated circuits. The event injector thereby simulates soft errors in the cache memory.

In the particular embodiment, the rare-event injector 100 is capable of injecting a sequence of rare events into a rare-event stimulus input selected from a variety of possible rare event stimulus inputs. The rare-event stimulus inputs include single and double-bit cache read errors ahead of error-detection and correction logic as heretofore described. In this embodiment, the injector is also capable of injecting rare-event stimulus inputs for causing parity errors in TLB locations, and parity errors in parity-protected branch-prediction circuitry.

In another embodiment of a complex processor IC, the injector is capable of causing delays in response by a cache to a read operation. In this embodiment, the injector is also capable of triggering cache snoop operations to particular cache addresses

In another embodiment, the injector is capable of forcing processor pipeline stalls or processor pipeline flush operations.

Apparatus is provided on the IC to prevent accidental operation of the pseudorandom rare-event injector in customer's systems. In an embodiment, the rare-event injector is enabled through a bonding option, with production devices sold to customers bonded so that the injector is disabled. In another embodiment, operation of the rare-event injector in customer systems is disabled through a fusible link. In yet another embodiment, operation of the rare-event injector requires writing a complex pattern to a key register to unlock access to the rare-event injector.

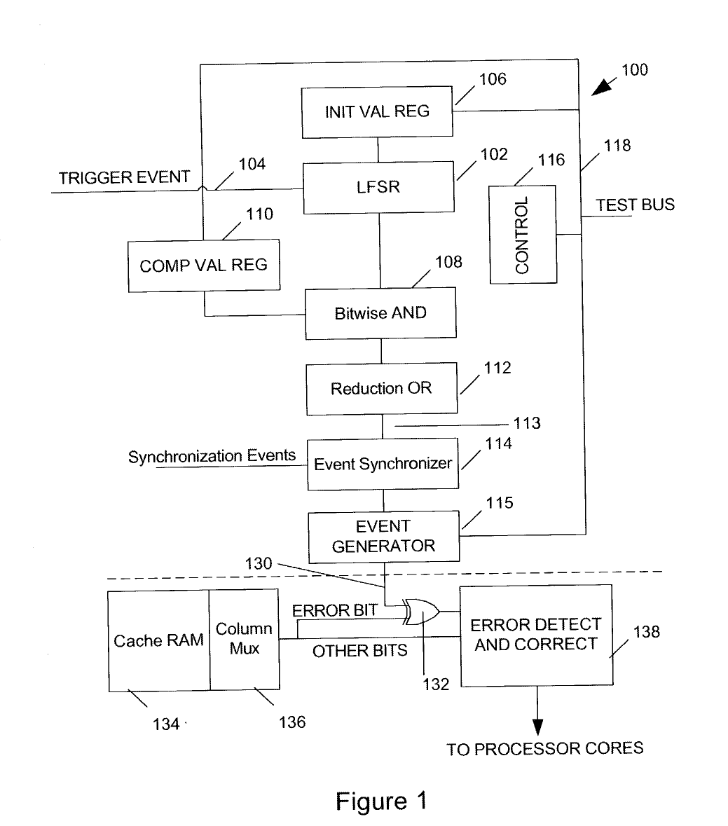

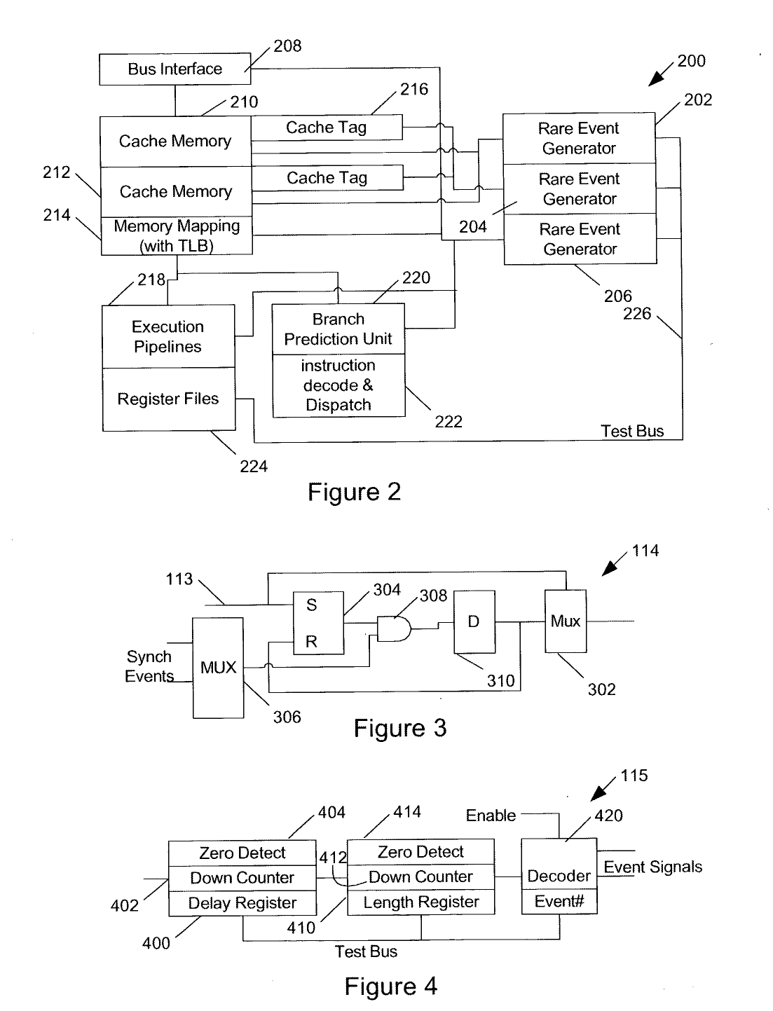

In an alternative embodiment embedded in a complex processor IC 200, there are multiple pseudorandom rare-event injectors 202, 204, 206 as heretofore described with reference to FIG. 1. Each pseudorandom rare-event injector 202, 204, 206 has separate initial value 106 and compare value 110 registers, as well as LFSR 102, bitwise AND 108, and reduction OR 112. This embodiment allows for generation of independent sequences of rare events on more than one rare-event stimulus input. Having multiple pseudorandom rare-event injectors permits exploration of IC function with, for example, parity errors in TLB locations occurring with or near single-bit correctable errors in cache.

The complex processor IC 200 has a bus interface 208, having a rare-event stimulus input to add bus delay and/or bus parity errors. There are also multiple levels of cache memory 210, 212, each having rare-event stimulus inputs for single and multiple-bit error injection that are driven by pseudorandom rare-event generators 202, 204, 206. In a particular embodiment, each level of cache is coupled to a separate rare-event injector to allow for design verification of cache errors near or at the same time in each level of cache. There is also a memory mapping unit 214, having a TLB, coupled such that a rare-event generator 206 can inject single-bit read errors. The complex processor IC 200 also has cache tag memories 216 and execution pipelines 218 as known in the art.

There are also a branch prediction unit 220, the branch prediction unit has memory coupled to a pseudorandom rare-event generator 206, separate from the rare-event generator 204 that is coupled to generate events in a lower level of cache memory 212. This permits creation of rare events in the branch prediction unit 220 near or at the same time as events in cache 212. There are also instruction decode and dispatch units 222 and register files 224 as required for a modem high-performance processor. The rare-event generators 202, 204, 206 are programmed over a test bus 226 that, in an embodiment, is addressable by the processor.

The particular embodiment of the on-chip rare-event injector is used during design verification to ensure that events similar to those injected will not cause faulty operation of the IC.

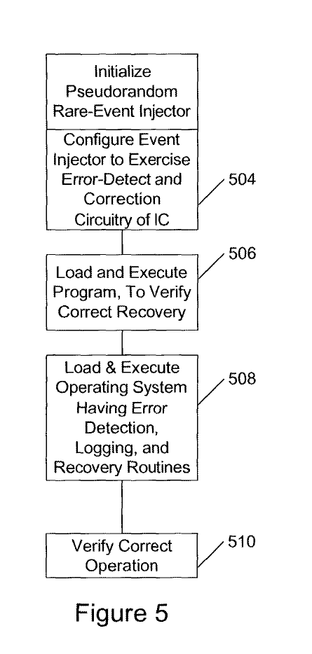

During the design verification process of FIG. 5, the rare-event injector is configured 504 to exercise the error-detect and correction circuitry of cache memory of the IC by injecting errors into data read from the cache. A cache test program is then loaded and executed 506 to verify that all data read to a processor of the integrated circuit from the cache system is correct, and that all instructions of the processor execute correctly. The cache test program thereby verifies that the injected errors were detected and corrected correctly by error detection and correction logic 138.

The injector is also used to verify error handling, error logging, and error recovery software features of an operating system intended to be used with the part. To do this, the pseudorandom sequence generator of the rare-event injector is initialized 502, and its event generator is configured 504 to inject errors into data read from the cache. The operating system is then loaded and executed 508 on a system incorporating the IC. Correct execution of test programs on the system is verified 510 to verify that injected errors were properly corrected or recovered from. Error logs from the operating system are inspected to determine that events were properly injected and logged. The steps of configuring 504, loading and executing 508, and verification 510 are repeated for errors injected into the TLB. Any problems found are fixed and the process repeated as necessary.

While the invention has been particularly shown and described with reference to particular embodiments thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. A rare-event injector for generating events in an integrated circuit, comprising:
first circuitry for generating a pseudorandom sequence of events having an output; and
second circuitry for coupling the output of the circuitry for generating a pseudorandom sequence of events to third circuitry for coupling events into circuitry of the integrated circuit to stimulate error handling and recovery circuitry of the integrated circuit.

2. The rare-event injector of claim 1, wherein the third circuitry is capable of simulating soft errors in a memory of the integrated circuit.

3. The rare-event injector of claim 2, wherein the circuitry for generating a pseudorandom sequence comprises a linear-feedback shift register.

4. The rare-event injector of claim 3, wherein the linear-feedback shift register is capable of being initialized to a programmable value.

5. The rare-event injector of claim 2, wherein the memory of the integrated circuit comprises cache memory associated with a processor of the integrated circuit.

6. The rare-event injector of claim 2, wherein the memory of the integrated circuit comprises a TLB.

7. The rare-event injector of claim 1, wherein the third circuitry is capable of inducing a stall in a pipeline of a processor.

8. The rare-event injector of claim 1, wherein the circuitry for coupling the output of the circuitry to circuitry for injecting events synchronizes events to synchronization events of the integrated circuit.

9. The rare-event injector of claim 8, wherein the synchronization events of the integrated circuit comprise events including read operations in a memory of the integrated circuit.

10. The rare-event injector of claim 2, further comprising
additional circuitry for generating a pseudorandom sequence of events having an output,
fifth circuitry for coupling the output of the additional circuitry for generating a pseudorandom sequence of events to additional circuitry for injecting events; and
additional circuitry for injecting events into circuitry of the integrated circuit to stimulate error handling and recovery circuitry of the integrated circuit.

11. The rare-event injector of claim 10, the injector being configurable such that the first circuitry for generating a pseudorandom sequence of events is capable of being coupled to cause injection of cache read errors, and the second circuitry for generating a pseudorandom sequence is capable of being coupled to cause TLB read errors.

12. The rare-event injector of claim 10, further comprising means to prevent operation of the rare-event injector in a customer's system.

13. A method of design verification of an integrated circuit, comprising the steps of:
generating a pseudorandom sequence of events within a first portion of circuitry of the integrated circuit; injecting the pseudorandom sequence of events into a second portion circuitry of the integrated circuit to produce a sequence of events at event detection and correction circuitry of the integrated circuit;
exercising the integrated circuit; and
verifying correct operation of the integrated circuit.

14. The method of claim 13, wherein the sequence of events at event detection and correction circuitry of the integrated circuit comprises a sequence of single-bit errors in memory of the integrated circuit.

15. The method of claim 14, wherein the memory of the integrated circuit is a cache memory.

16. The method of claim 14, wherein exercising the integrated circuit comprises executing a test program on a processor of the integrated circuit.

17. The method of claim 16, wherein exercising the integrated circuit comprises executing an operating system on the integrated circuit, whereby correctness of the operating system is verified.
